(19) United States
(12) Patent Application Publication
(10) Pub. No.: US 2025/0252942 A1
(43) Pub. Date: Aug. 7, 2025

(54) Guitar Bag

(71) Applicant: HUIZHOU KAYON BAG CO., LTD., Huizhou (CN)

(72) Inventors: Guowei LYU, Huizhou (CN); Guohao Lyu, Huizhou (CN); Guojia Lyu, Huizhou (CN)

(21) Appl. No.: 19/007,032

(22) Filed: Dec. 31, 2024

(30) Foreign Application Priority Data
Feb. 4, 2024 (CN) 202420276424X

(51) Int. Cl. G10G 7/00

(52) U.S. Cl. CPC G10G 7/005

(57) ABSTRACT

A guitar bag, consisting of a main body, a zipper and a handle, is provided in this application. The main body comprises a lower body and an upper body. The lower body includes a base and side panels, with the side panels surrounding the base. The upper body includes a cover and cover panels, with the cover panels surrounding the cover. The zipper is positioned between the base and the cover, with one side connected to the side panels and the other connected to the cover panels. The handle is positioned on the side panels. The connecting surface between the base and the cover is divided into side panels and cover panels, with the side panels arranged on the base and the cover panels arranged on the cover. When the guitar is tilted upward for removal, its side body is less likely to collide with the upper body.

### TECHNICAL FIELD

This utility model relates to the technical field of accessories for musical instruments, specifically to a guitar bag.

### BACKGROUND

Known as Jieta or six-string instrument, the guitar is a plucked string instrument with typically six strings and a shape resembling a violin. It is a principal instrument in genres such as pop, rock, blues, folk, and flamenco. In classical music, the guitar is often played as a solo or duet instrument. It also serves a complementary role in chamber and orchestral performances. Alongside the violin and piano, the classical guitar is recognized as one of the most prominent instruments in the world. Structurally, a guitar consists of the headstock, neck, and body, which includes the resonator.

The guitar bag is a case designed to hold guitars, facilitating their transport and preventing damage to components. As shown in FIGS. 1 and 2, a traditional guitar bag consists of a main body, a cover, a zipper, and a handle. The main body includes a bottom panel and side panels, in which the side panels enclose the bottom panel. The cover is a flat lid, with part of its edge connected to one side of the main body. One side of the zipper is attached to the remaining edges of the main body, while the other side is attached to the remaining edges of the cover.

To retrieve the guitar, the guitar bag must be laid flat on the ground, the zipper opened, the cover lifted, and the guitar removed. However, there are disadvantages with this method: the ground may be dirty, causing the main body to become soiled, and users need to crouch and bend over to operate.

To enable guitar retrieval without laying the bag flat on the ground, the opening method of the guitar bag has evolved from a traditional side-opening design to a front-and-back opening method connected at the bottom, as shown in FIGS. 3 and 4. In this design, the main body and the cover open from front to back, so that the guitar could be lifted upwards. Typically, the lower cavity of a traditional acoustic guitar exceeds eight to ten cm in thickness, corresponding to the thickness of the soundbox, which generally exceeds eight to ten cm. Due to this characteristic, it leads to a structural limitation in practical applications of this type of guitar bag: When lifting the guitar vertically upward, the soundbox will collide with the side panels of the main body. This prevents the guitar from being removed vertically and, over time, may cause damage to the guitar's soundbox.

In view of these issues, existing guitar bags still need to be improved.

### Content of the Utility Model

To address the shortcomings of existing technologies, this application provides a guitar bag.

The guitar bag disclosed in this application consists of a main body, a zipper, and a handle. The main body includes a lower body and an upper body. The lower body consists of a bottom panel and side panels, with the side panels enclosing the bottom panel. The upper body comprises a cover and cover side panels, with the cover side panels enclosing the cover. One side of the zipper is connected to the side panels, while the other is connected to the cover side panels. The handle is positioned on the side panels.

Preferably, when the zipper fastens the upper body to the lower body, the distance between the handle and the bottom panel is L1, and that between the handle and the cover is L2, where L1=L2.

Preferably, the main body includes a neck and a cavity. In the neck section, when the zipper fastens the upper body to the lower body, the distance between the zipper and the cover is d1, and that between the zipper and the bottom panel is d2, where d1≥d2/3.

Preferably, when the zipper fastens the upper body to the lower body in the cavity section, the distance between the zipper and the cover is h1, and that between the zipper and the bottom panel is h2, where h2>h1≥h2/3.

Preferably, when the zipper fastens the upper body to the lower body, in the neck section, the distance between the zipper and the cover is d1, and that between the zipper and the bottom panel is d2. In the cavity section, the distance between the zipper and the cover is h1, and that between the zipper and the bottom panel is h2, where d1=d2/2 and h1=h2/2.

Preferably, in the direction from the neck to the cavity, the distance between the zipper and the bag cover gradually decreases, while that between the zipper and the bag base gradually increases.

In the direction from the neck to the cavity, the distance between the zipper and the cover gradually decreases, while the distance between the zipper and the bottom panel gradually increases.

Preferably, when the zipper closes the upper and lower body of the bag, at the cavity, the distance between the zipper and the cover is h3, and the distance between the zipper and the bottom panel is h4, where h3<h4.

Preferably, the bottom panel and the side panels are formed as an integrated structure.

Preferably, the cover and the cover side panels are formed as an integrated structure.

The beneficial effect of this application lies in: The connecting side surface between the bottom and the cover of the bag is divided into the side wall of the bag and the side wall of the cover, with the side wall of the bag set on the bottom and the side wall of the cover set on the cover. The depth of the groove formed by the side wall and the bottom is reduced. This facilitates removal of the guitar from the lower body of the bag. When the guitar is tilted upwards for removal, its body is less likely to collide with the upper body of the bag.

### DESCRIPTION OF THE DRAWINGS

The drawings described here are provided to facilitate a deeper understanding of this application. They form a part of this application and illustrate exemplary embodiments and explanations. These are not intended to unduly limit the scope of the application. In the drawings:

FIG. 1 is one schematic diagram of a guitar bag from the background art

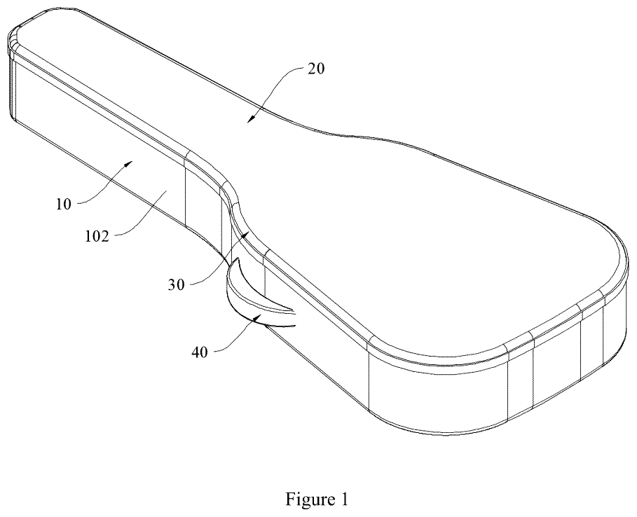

FIG. 2 is another schematic diagram of a guitar bag from the background art

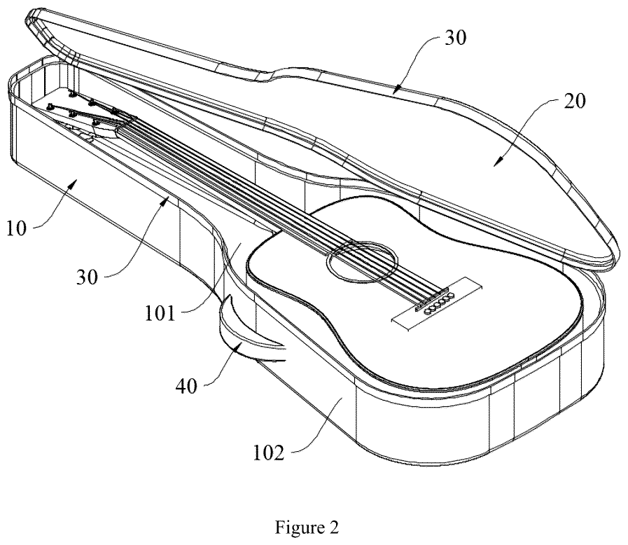

FIG. 3 is a third schematic diagram of a guitar bag from the background art

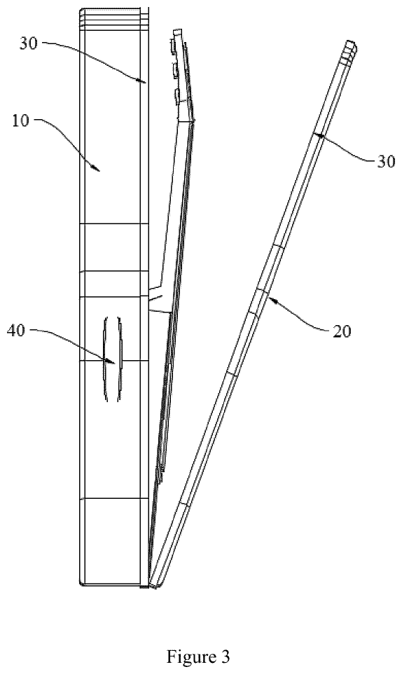

FIG. 4 is a fourth schematic diagram of a guitar bag from the background art

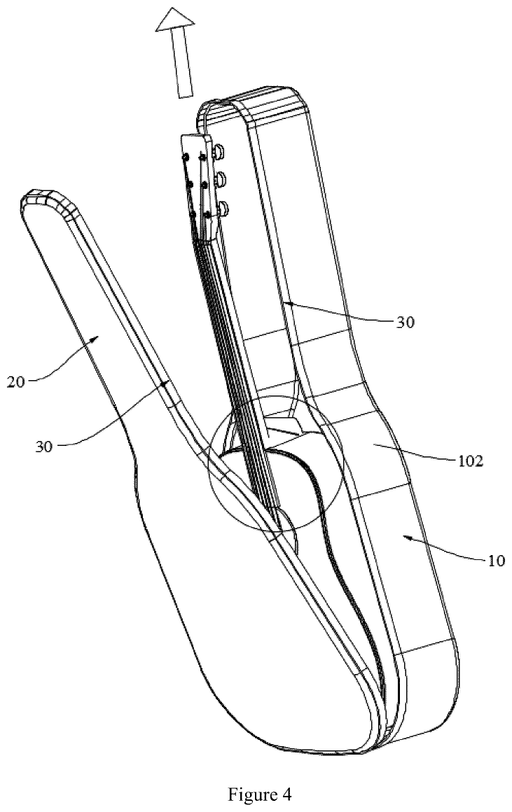

FIG. 5 is a perspective view of the guitar bag in an embodiment View 1

FIG. 6 is a perspective view of the guitar bag in an embodiment View 2

FIG. 7 is a schematic diagram of the positional relationship between the neck and the cavity in an embodiment

FIG. 8 is a schematic diagram of guitar removal in an embodiment View 1

FIG. 9 is a schematic diagram of guitar removal in an embodiment View 2

FIG. 10 is a perspective view of the guitar bag in an embodiment View 3

FIG. 11 is a perspective view of the guitar bag in an embodiment View 4

FIG. 12 is a perspective view of the guitar bag in an embodiment View 5

### REFERENCE NUMERALS

Main body; zipper; handle;
lower body; upper body; neck; cavity;
base; side panel;
cover; cover panel.

### SPECIFIC IMPLEMENTATION

The following disclosure presents several implementations of this application with reference to the accompanying drawings. For clarifying the description, many practical details will be included in the following explanation. Notably, these practical details are not meant to limit the scope of the application. In other words, these practical details are not essential in some of the implementations provided herein. Furthermore, for the sake of simplifying the drawings, certain commonly known structures and components are represented in a simple schematic form.

It is noteworthy that in the implementations of this application, all directional indications such as upper, bottom, left, right, front, and back are used only to describe the relative positions, movements, and relationships between components in a particular orientation as shown in the drawings. If the orientation is altered, these directional terms will change accordingly to reflect the new position.

In addition, any references to “first,” “second,” and similar terms within this application are used for descriptive purposes only but do not specifically indicate sequence or priority. These terms are only intended to distinguish between components or operations described using the same technical language and should not be interpreted as indicating or implying their relative importance or the quantity of the technical features mentioned. Thus, features labeled “first” or “second” can explicitly or implicitly include at least one of those features.

Moreover, the technical solutions described in different implementations can be combined. However, such combinations must be feasible and achievable based on the knowledge and capabilities of those skilled in the art. If a combination of technical solutions triggers contradictions or is unimplementable, such a combination should be considered non-existent and will not be considered within the scope of protection sought in this application.

To provide a deeper understanding of the content, characteristics, and advantages of this application, the following examples are presented along with detailed explanations through the accompanying drawings.

### Example 1

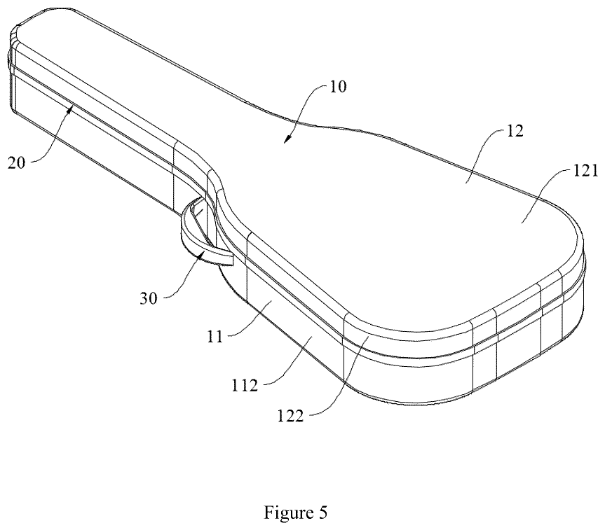

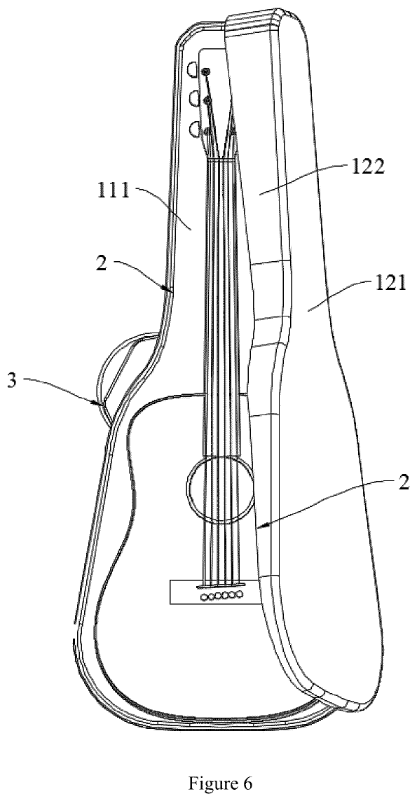

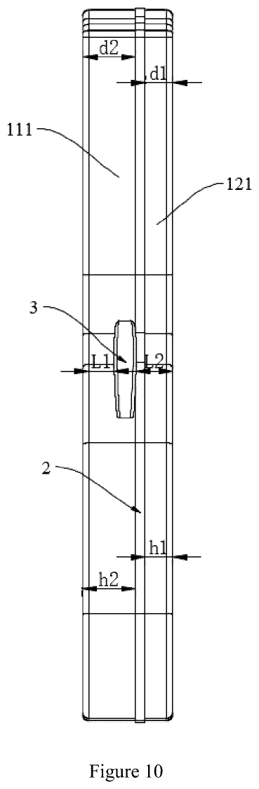

Refer to FIGS. 5, 6, and 10. FIG. 5 is a perspective view of the guitar bag in an embodiment, FIG. 6 is another perspective view of the guitar bag in an embodiment, and FIG. 10 is a perspective view of the guitar bag in an embodiment. The guitar bag in this example includes a main body, a zipper, and a handle. The main body is used to house the guitar, the zipper is used to open and close the main body, and the handle serves as a convenient carrying feature.

The body consists of a lower body and an upper body. The lower body includes a bottom and a side panel, while the upper body includes a cover and a cover panel. The base and the cover together form the front and back of the guitar bag, with the base and cover arranged in parallel at a certain distance. The side panel is erected on the base and surrounds the perimeter of the base, with the side panel facing the cover. The cover panel is erected on the cover and surrounds the perimeter of the cover, with the cover panel facing the base. The lower body and the upper body together form a closed space to accommodate the guitar. The zipper is positioned between the lower body and the upper body, with one side of the zipper connected to the side panel and the other side connected to the cover panel. The zipper is used to open and close the upper body and the lower body. The handle is located on the side panel, and the side panel and the cover panel jointly form the sides of the body. The projections of the base and the cover resemble the projection of a guitar when viewed from above.

When the user needs to remove the guitar from the body, they pull the zipper to open the bag in a way that allows for forward and backward opening. Then, the guitar is removed upward. During this process, given that the cover side panel is attached to the cover, when the upper body is lifted, the cover panel lifts with it. The side panel on the base is relatively low in height. Thus, upon removal of the guitar, the guitar only needs to be slightly separated from the base to be taken out from between the lower body and the upper body. The guitar is less likely to collide with the upper body.

The connecting side between the base and the cover is divided into the side panel and the cover panel, with the side panel located on the base and the cover panel on the cover, the depth of the groove formed between the side panel and the base is reduced. This facilitates removal of the guitar from the lower body. When the guitar is tilted upward during removal, its body is less likely to collide with the upper body.

Furthermore, when the zipper pulls the upper body and the lower body together, the distance between the handle and the base is L1, and the distance between the handle and the cover is L2. L1=L2, indicating that the handle is positioned at the center between the upper body and the lower body. This ensures that the weight distribution between the upper body and the lower body is more balanced when the user lifts the guitar bag using the handle.

### Example 2

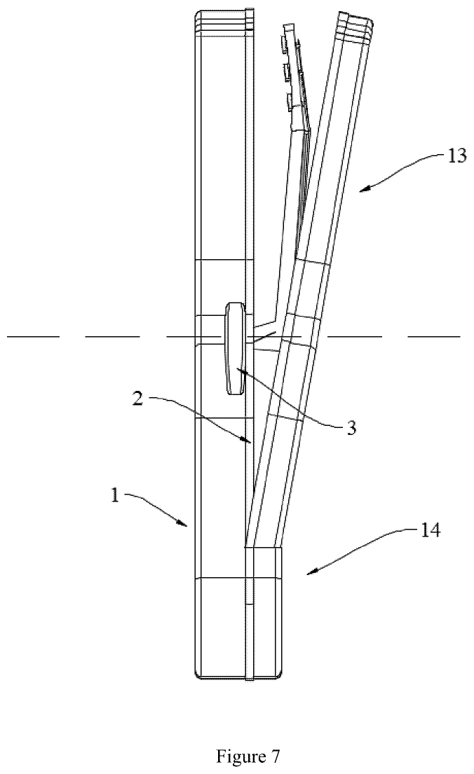

As mentioned earlier, please also refer to FIG. 7. FIG. 7 is a schematic diagram of the positional relationship between the neck and the cavity in an embodiment. The main body of the guitar bag has a neck and a cavity. The neck and the cavity are located at opposite ends of the main body. The cross-sectional area of the cavity is larger than that of the neck. The neck is designed to accommodate the guitar neck and the part above it. In other words, the neck is used to house the guitar neck and the section above it, while the cavity is designed to house the resonator box, meaning that it is used to accommodate the section of the guitar below the neck. When the zipper is pulled to close the upper body and lower body, the distance between the zipper and the cover at the neck is d1, and the distance between the zipper and the base is d2. It holds that d1≥d2/3. In other words, the distance between the zipper and the cover at the neck is at least one-third of the distance between the zipper and the base. That is to say, at the neck, the height of the side panel of the lower body is at most three times the height of the cover side panel. Furthermore, at the neck, the depth of the cavity formed by the lower body is at least one-third of the depth of the cavity formed by the upper body. Additionally, the depth of the cavity formed by the lower body is at least one-quarter of the thickness of the guitar bag.

Hence, when the distance between the zipper and the cover at the neck is at least one-third of the distance between the zipper and the bottom, or when the distance between the zipper and the cover in the cavity is at least one-quarter of the distance between the cover and the base, it ensures that the guitar can be removed vertically from the main body without colliding with the upper body or the lower body.

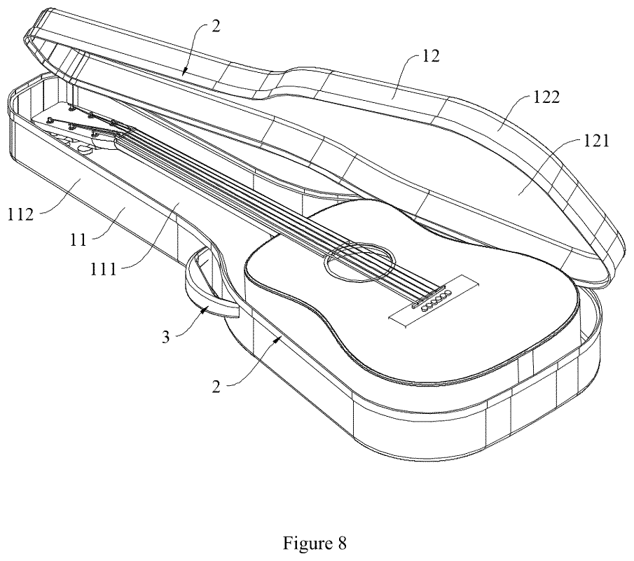

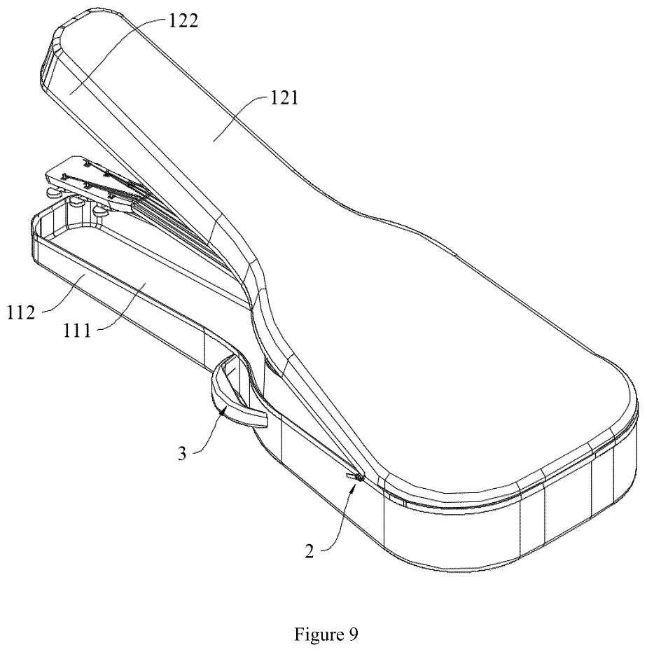

It is worth mentioning that the method of removing the guitar is not limited to vertical removal. It can also follow any of the removal methods shown in FIGS. 7, 8, and 9. FIG. 8 is one of the schematic diagrams of guitar removal in an embodiment, and FIG. 9 is another schematic diagram of guitar removal in an embodiment.

### Example 3

Referring to Example 2, please also review FIGS. 5, 7, 8, and 10. When the zipper is pulled to close the upper body and lower body, the distance between the zipper and the cover in the cavity is at least half of the distance between the zipper and the base. Additionally, the distance between the zipper and the cover is smaller than the distance between the zipper and the base. Namely, at the neck, the distance between the zipper and the cover is d1, and the distance between the zipper and the base is d2, where d1≥d2/2.

In this example, at both the neck and the cavity, the distance between the zipper and the cover is half the distance between the zipper and the cover. In other words, d1=d2/2, and h1=h2/2.

Hence, this design facilitates the removal of the guitar from the main body, while allowing the handle to be positioned at the central location between the base and the cover. Specifically, the handle is set on the side panel, facilitating users to carry the guitar bag. With the handle, the weight of the guitar bag is more evenly distributed. Additionally, given that the distance between the zipper and the cover is smaller than the distance between the zipper and the bottom, it avoids the issue of the zipper distance being equal. Thus, it is impossible to place the handle at the central position.

Furthermore, the distance between the handle and the base is equal to that between the handle and the cover. In other words, the handle is positioned at the central point between the base and the cover.

Moreover, the base and the side panel are integrated as a single structure, and the cover and the cover panel are also integrated as one piece. That is to say, the base and the side panel form a unified structure, and the cover and the cover panel form another unified structure.

In this way, this design ensures the structural strength of the main body's connections.

### Example 4

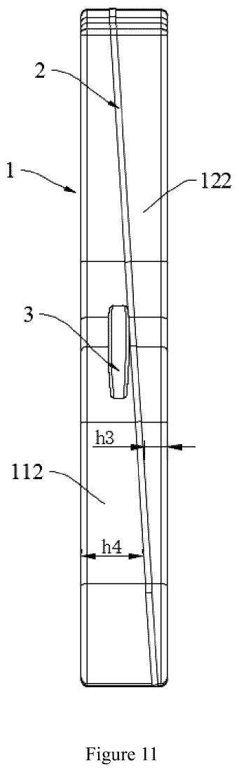

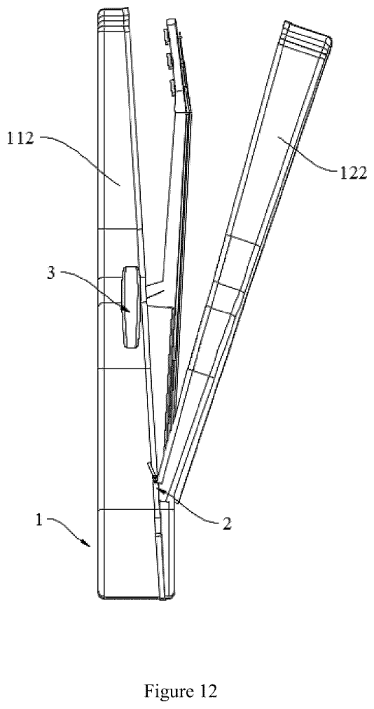

With reference to Example 2, please also refer to FIGS. 11 and 12. FIG. 11 presents a perspective view of the guitar bag in an embodiment, and FIG. 12 shows another perspective view of the guitar bag in an embodiment. In the direction from the neck to the cavity, i.e., from the upper end to the lower end of the guitar bag, the distance between the zipper and the cover gradually diminishes, while that between the zipper and the bottom gradually increases.

Consequently, in comparison to the previous examples, the guitar is more effortlessly extracted from the bag without the resonance box coming into contact with the guitar bag during the removal process.

In addition, when the zipper is engaged to close the upper body and the lower body, within the cavity, the distance between the zipper and the cover is denoted as h3, and the distance between the zipper and the base is denoted as h4, where h3<h4. In other words, the distance between the zipper and the cover is smaller than that between the zipper and the bottom.

In this way, this configuration enables the handle to be centrally positioned on the side panel of the cavity, thereby preventing the zipper from obstructing or segmenting the handle. A single handle can also be positioned on the side panel.

In conclusion, the connecting sides between the base and the cover are segmented into the side panel and cover side panel, with the side panel located on the base and the cover panel on the cover. The depth of the groove formed by the side panel and the base is reduced. This makes the guitar significantly easier to extract from the lower body. When the guitar is tilted upwards for removal, it is less likely to collide with the upper body.

The above is merely an embodiment of this application and should not be construed as a limitation. For those skilled in the art, various modifications and adaptations can be made. Any modifications, equivalent substitutions, or improvements made within the scope and principles of this application are intended to be covered by the claims of this application.

1. A guitar bag consists of: a main body, a zipper, and a handle. The main body includes a lower body and an upper body. The lower body comprises a base and side panels, with the side panels surrounding the base. The upper body comprises a cover and cover panels, with the cover panels surrounding the cover. One side of the zipper is connected to the side panels, while the other is connected to the cover panels. The handle is positioned on the side panels.

2. According to claim 1, the guitar bag is characterized in that when the zipper closes the upper body and the lower body, the distance between the handle and the base is L1, and the distance between the handle and the cover is L2, where L1=L2.

3. According to claim 1, the guitar bag is characterized in that the main body includes a neck and a cavity. When the zipper closes the upper body and the lower body, at the neck, the distance between the zipper and the cover is d1, and the distance between the zipper and the base is d2, where d1≥d2/3.

4. According to claim 3, the guitar bag is characterized in that when the zipper closes the upper body and the lower body, at the cavity, the distance between the zipper and the cover is h1, and the distance between the zipper and the base is h2, where h2>h1≥h2/3.

5. According to claim 4, the guitar bag is characterized in that when the zipper closes the upper body and the lower body, at the neck, the distance between the zipper and the cover is d1, and the distance between the zipper and the base is d2. At the cavity, the distance between the zipper and the cover is h1, and the distance between the zipper and the base is h2, where d1=d2/2 and h1=h2/2.

6. According to claim 3, the guitar bag is characterized in that in the direction from the neck to the cavity, the distance between the zipper and the cover gradually decreases, while the distance between the zipper and the base gradually increases.

7. According to claim 6, the guitar bag is characterized in that when the zipper closes the upper body and the lower body, at the cavity, the distance between the zipper and the cover is h3, and the distance between the zipper and the base is h4, where h3<h4.

8. According to claim 1, the guitar bag is characterized in that the base and the side panels form an integrated structure.

9. According to claim 1, the guitar bag is characterized in that the cover and the cover panels form an integrated structure.
